(19) United States
(12) Patent Application Publication
(10) Pub. No.: US 2010/0174590 A1
(43) Pub. Date: Jul. 8, 2010

(54) ADVERTISING DEVICE AND METHOD THEREFOR

(76) Inventor: Alden Crowley, Las Vegas, NV (US)

Correspondence Address: WEISS & MOY PC, 4204 NORTH BROWN AVENUE, SCOTTSDALE, AZ, 85251, US

(21) Appl. No.: 12/349,144

(22) Filed: Jan. 6, 2009

(51) Int. Cl. G06Q 30/00; G09F 3/18; G09F 3/08

(52) U.S. Cl. 705/14.4; 40/642.02; 40/320

(57) ABSTRACT

The advertising device has a frame having a recessed front surface surrounded by a protrusive edge. A plurality of slots is formed along the protrusive edge proximate the recessed front surface. At least one insert is provided. The insert has a plurality of tabs capable of being inserted into the plurality of slots.

### FIELD OF THE INVENTION

The present invention relates to advertising, and more specifically, to an open-faced advertising device to be attached to an airplane seat and being able to hold a variety of interchangeable inserts.

### BACKGROUND OF THE INVENTION

With increasing fuel costs adding to the cost of operating a commercial airliner and other modes of transportation, airline companies and other mass transportation companies are trying to find new ways to capitalize on untapped sources of potential revenue. Furthermore, advertisers continually look for alternative avenues for advertisement. Thus, it would be beneficial to provide an inexpensive means for new advertising outlets for advertisers while concurrently enabling commercial airline and other mass transportation companies to capitalize on untapped sources of potential revenue.

The effectiveness of any advertisement on a mass transit vehicle may depend on the final destination of the individual viewing the advertisement. Accordingly, the interchangeability of advertisements on these different modes of mass transportation having various destinations helps to make advertising more effective by being applicable to a variety of narrower and more specific demographics.

Presently, many of the current forms of advertising on modes of mass transportation are bulky, and are often designed to deter removal of an advertisement by adding additional material to lock the advertisement in place. Locking the advertisement in place makes the act of changing advertisements a difficult and unnecessarily expensive task, while also adding to the overall weight of the advertising device.

Therefore, it would be beneficial to provide an advertising device and method to over comes the above problems associated with prior art devices. The system and method will enable advertising operators to easily change various advertisements within various modes of transportation. The system and method will place the advertisements in close proximity to, and directly in front of, the passengers being transported, while adding only minimal weight to the mode of transportation.

### SUMMARY OF THE INVENTION

In accordance with one embodiment, an advertising device is disclosed. The advertising device has a frame having a plurality of slots. At least one insert is provided. The insert has a plurality of tabs capable of being inserted into the plurality of slots.

In accordance with another embodiment of the present invention, an advertising device is disclosed. The advertising device has a frame having a recessed front surface surrounded by a protrusive edge. A plurality of slots is formed along the protrusive edge proximate the recessed front surface. At least one insert is provided. The insert has a plurality of tabs capable of being inserted into the plurality of slots.

The features, functions, and advantages can be achieved independently in various embodiments of the disclosure or may be combined in yet other embodiments.

### BRIEF DESCRIPTION OF THE DRAWINGS

Embodiments of the disclosure will become more fully understood from the detailed description and the accompanying drawings, wherein:

FIG. 1 is a first elevated perspective view of one embodiment of the frame of the advertising device with the bottom edge of the frame rotated upwardly slightly;

FIG. 2 is a second elevated perspective view of the frame of the embodiment shown in FIG. 1 with the top edge of the frame rotated upwardly slightly;

FIG. 3 is an elevated perspective view of an embodiment of the advertising insert used in the frame shown in FIGS. 1 and 2;

FIG. 4 is an elevated perspective view of the embodiment of the advertising device collectively shown in FIGS. 1-3 attached to the back of an airplane seat;

FIG. 5 is a first elevated perspective view of another embodiment of a frame of an advertising device with the top edge of the frame rotated upwardly slightly;

FIG. 6 is a second elevated perspective view of the embodiment of the frame shown in FIG. 5 with the bottom edge rotated upwardly slightly;

FIG. 7 is an elevated perspective view of another embodiment of an advertising insert that is used with the embodiment of the frame shown in FIGS. 5 and 6; and

FIG. 8 is an elevated perspective view of the embodiment of the advertising device collectively shown in FIGS. 5-7 attached to the back of an airplane seat.

Common reference numerals are used throughout the drawings and detailed description to indicate like elements.

### DETAILED DESCRIPTION OF THE PREFERRED EMBODIMENTS

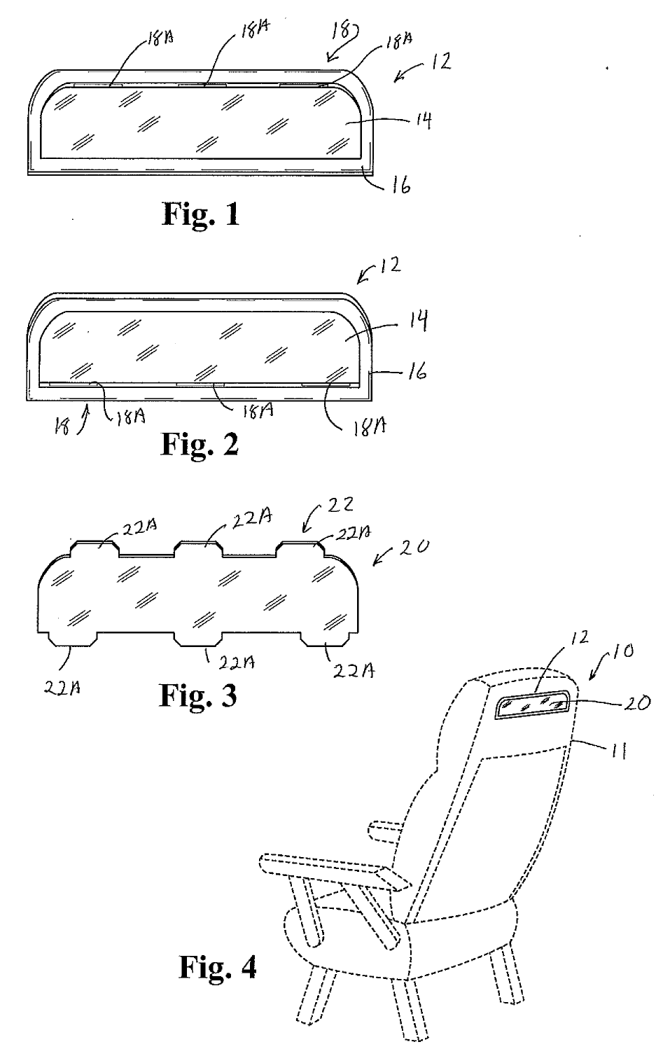

Referring to FIGS. 1-4, one embodiment of an advertising device 10 is shown. The advertising device 10 will provide an effective advertising outlet that is lightweight and capable of having different advertisements that are easily changed, while conforming to FAA and EASA standards.

As shown in FIGS. 1-2, the advertising device 10 has a frame 12. The frame 12 shown is a flat, predominantly rectangular piece of FAA and EASA approved plastic or thermoplastic sheets. However, the frame 12 may be made of different materials and may come in different shapes without departing from the spirit and scope of the present invention. The frame 12 has a recessed front surface 14. In the embodiment shown in FIGS. 1-2, the recessed front surface 14 makes up the majority of the surface area of the face of the frame 12. However, this is shown only as an example and should not be seen as to limit the scope of the present invention. An edge 16 is formed around the perimeter of the recessed front surface 14.

The frame 12 has a plurality of connectors 18. The connectors 18 are used for securing an advertising insert 20 (FIG. 3) to the frame 12. In accordance with one embodiment, the connectors 18 are slots 18A which are, in the preferred embodiment, located proximate the recessed front surface 14 and through the edge 16 of the frame 12. In the embodiment shown in FIGS. 1-2, there are three slots 18A near the top edge of the frame 12, each slot 18A being directly across from each of three slots 18A near the bottom edge of the frame 12. However, this is only shown as an example and different configurations and numbers of slots 18 may be used without departing from the spirit and scope of the present invention.

As shown in FIG. 3, the interchangeable advertising insert 20 is shown. In general, the advertising insert 20 is predominantly of the same shape and dimensions of the recessed front surface 14 of the frame 12. The advertising insert 20 has a plurality of connectors 22. The connectors 22 join with corresponding connectors 18 on the frame 12 to secure the advertising insert 20 to the frame 12. In accordance with the embodiment shown in FIG. 3, the connectors 22 are tabs 22A. The tabs 22A extend from the perimeter of the advertising insert 20 and are capable of being inserted into the various corresponding slots 18A of the frame 12, enabling secure placement of the advertising inserts 20 within the recessed front surface 14 of the frame 12 as shown in FIG. 4. Accordingly, the advertising insert 20 is held in place by the interlocking of the advertising insert 20 with the frame 12 without the need to have a cover to secure the advertising insert 20. This feature is beneficial in that it reduces the overall mass of the advertising device 10 while simultaneously eliminating material that could be potentially hazardous in the event of a crash or strong turbulence.

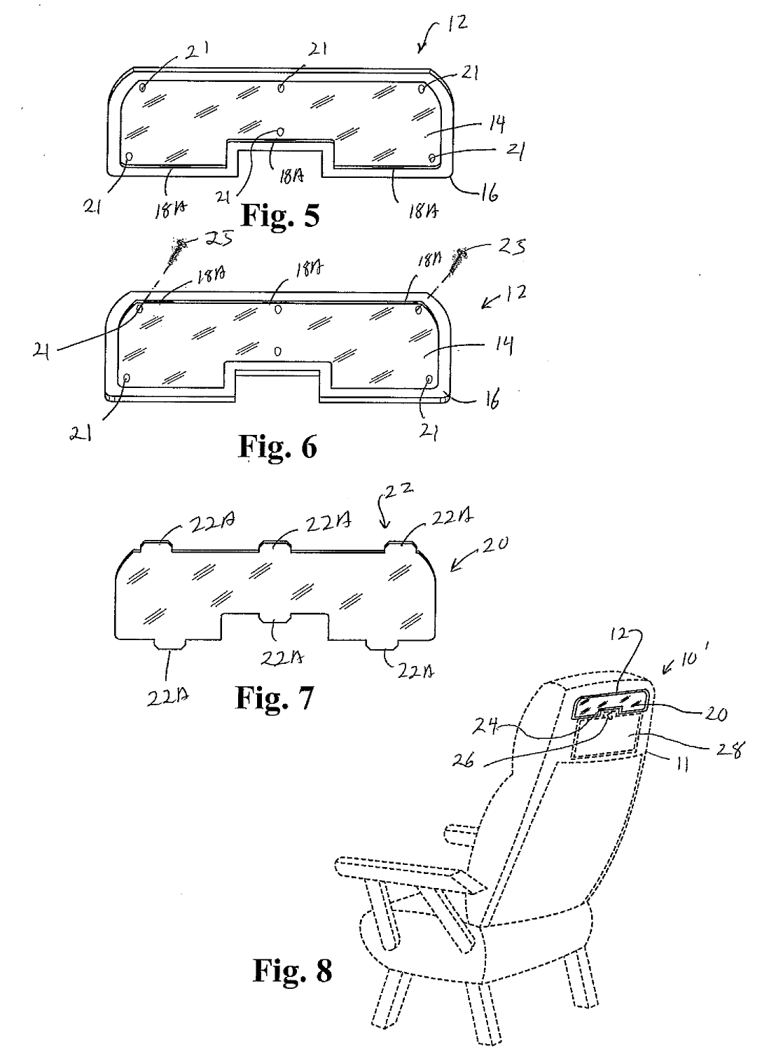

Referring to FIG. 5-8, another embodiment of the advertising device 10′ of the present invention is shown. The advertising device 10′ will have a frame 12 that is made of FAA and EASA approved plastic, although the frame 12 may be made of different materials without departing from the spirit and scope of the present invention. The frame, shown in FIGS. 5 and 6, is predominantly rectangular, but also has a small rectangular niche 24 in the center area of its bottom edge. This niche 24 enables the advertising device 10′ to be placed upon an airplane seat 11 about a tray's locking mechanism 26, shown in FIG. 8, without interfering with the range of motion of the tray 28. The frame 12 has a recessed front surface 14. In the embodiment shown in FIGS. 5-6, the recessed front surface 14 makes up the majority of the surface area of the face of the frame 12. However, this is shown only as an example and should not be seen as to limit the scope of the present invention. An edge 16 is formed around the perimeter of the recessed front surface 14.

The frame 12 also has a plurality of connectors 18. The connectors 18 are used for securing the advertising insert 20 to the frame 12. In accordance with one embodiment, the connectors 18 are slots 18A proximate the recessed front surface 14 and through the edge 16. In accordance with one embodiment of the advertising device 10′ having a niche 24, the frame 12 has at least one slot 18A above the rectangular niche 24 and at least one slot 18A on the bottom edge of the frame 12 on each side of the niche 24, each of these slots 18A having a corresponding slot 18 directly across from them, near the top of the frame 12. However, the slots 18A may be positioned elsewhere on the frame 12 without departing from the spirit and scope of the present invention.

Referring to FIG. 7, the advertising device 10′ of this embodiment will also have at least one interchangeable advertising insert 20. In general, the advertising insert 20 is predominantly of the same shape and dimensions of the recessed front surface 14 of the frame 12. The advertising insert 20 has a plurality of connectors 22. The connectors 22 join with corresponding connectors 18 on the frame 12 to secure the advertising insert 20 to the frame 12. In accordance with the embodiment shown in FIG. 7, the connectors 22 are tabs 22A. The tabs 22A extend from the perimeter of the advertising insert 20 and are capable of being inserted into the various corresponding slots 18A of the frame 12, enabling secure placement of the advertising inserts 20 within the recessed front surface 14 of the frame 12 as shown in FIG. 8. Accordingly, the advertising insert 20 is held in place by the interlocking of the advertising insert 20 with the frame 12 without the need to have a cover to secure the advertising insert 20. This feature is beneficial in that it reduces the overall mass of the advertising device 10 while simultaneously eliminating material that could be potentially hazardous in the event of a crash or strong turbulence.

As shown in FIGS. 4 and 8, the frame 12 of the advertising devices 10 and 100 is preferably secured to the back of an airplane seat 11 by coupling first connectors placed through the frame 12 with second connectors housed in the back of the airplane seat 11. The first and second connectors are generally FAA or EASA approved connectors such as screws, rivets, rivet nuts, and the like. However, it should be noted that the frame 12 may be secured to the back of the airplane seat 11 via various other mechanisms, such as by the use of a FAA or EASA approved adhesive, or by directly integrating the frame 12 with the back of the airplane seat 11.

### Statement of Operation

In accordance with one embodiment of the method of installing the advertising device 10 and 10′, the advertising device 10 and 10′ is installed on an airplane seat 11 by providing a frame 12 and positioning the frame 12 on a seat 11. Thereafter a plurality of holes 21 are drilled through the frame 12, through the seat cover, through the web of the seat back, and through the metal plate of the seat back. The plurality of holes 21 in the web of the seat back is then deburred, and frame connectors (not shown) are installed into each of the plurality of holes in the web of the seat back. Then, a fabric punching mechanism is used on each of the plurality of holes in the seat cover, and a press grommet is used to install a grommet (not shown) and a washer (not shown) in each of the plurality of holes in the seat cover. The frame 12 is then again positioned on the seat back and connectors 25 are coupled through the holes 21 in the frame 12 with each of the connectors 25. Thereafter, the advertising insert 20 may be coupled to the frame 12 by placing the tabs 22 of the insert 20 into the slots 18 of the frame 12.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. An advertising device comprising:
a frame having a plurality of slots; and
at least one insert having a plurality of tabs capable of being inserted into the plurality of slots.

2. The advertising device of claim 1 wherein the frame is made of one of Federal Aviation Administration approved thermoplastic sheets or Federal Aviation Administration approved material.

3. The advertising device of claim 1 wherein the frame is made of one of European Aviation Safety Agency approved thermoplastic sheets or European Aviation Safety Agency approved material.

4. The advertising device of claim 1 wherein the frame has a recessed front surface.

5. The advertising device of claim 1 wherein the frame is secured to a back of a seat of an airplane.

6. The advertising device of claim 1 wherein the frame has a recessed front surface, the recessed front surface surrounded by a protrusive edge.

7. The advertising device of claim 6 wherein the plurality of slots is formed along the protrusive edge proximate the recessed front surface.

8. The advertising device of claim 6 wherein the dimensions of the insert enables placement of the insert entirely within the protrusive edge and proximate the recessed front surface.

9. The advertising device of claim 6 further comprising:
a niche formed in the frame.

10. The advertising device of claim 9 wherein the niche is formed in a center area of a bottom edge of the frame and is rectangular in shape and has a top and two sides.

11. The advertising device of claim 10 wherein the insert has a cutout corresponding to the niche formed in the center area of the bottom edge of the frame enabling placement of the insert entirely within the protrusive edge and proximate the recessed front surface.

12. The advertising device of claim 11 wherein the frame has a plurality of holes through the recessed front surface and is secured to a back of a seat of an airplane by a plurality of first connectors through the plurality of holes and into a plurality of second connectors housed in the back of a seat of an airplane.

13. An advertising device comprising:
a frame having a recessed front surface surrounded by a protrusive edge and having a plurality of slots formed along the protrusive edge proximate the recessed front surface;
at least one insert having a plurality of tabs capable of being inserted into the plurality of slots.

14. The advertising device of claim 13 wherein the frame is made of one of Federal Aviation Administration approved thermoplastic sheets or Federal Aviation Administration approved material.

15. The advertising device of claim 13 wherein the frame is made of one of European Aviation Safety Agency approved thermoplastic sheets or European Aviation Safety Agency approved material.

16. The advertising device of claim 13 wherein the frame has a niche formed in a center area of a bottom edge of the frame that is rectangular in shape and has a top and two sides.

17. The advertising device of claim 16 wherein the insert has a cutout corresponding to the niche formed in the center area of the bottom edge of the frame enabling placement of the insert entirely within the protrusive edge and proximate the recessed front surface.

18. A method of advertising comprising:
providing a frame, the frame comprising:
a recessed front surface, the recessed front surface being surrounded by a protrusive edge;
a plurality of slots through the protrusive edge proximate the recessed front surface;
providing at least one insert having a plurality of tabs being able to be inserted into the plurality of slots;
coupling the frame to a rear of an airplane seat.

19. The method of advertising of claim 18 wherein the frame is comprised of one of Federal Aviation Administration approved thermoplastic sheets or European Aviation Safety Agency approved thermoplastic sheets or both Federal Aviation Administration and European Aviation Safety Agency approved thermoplastic sheets.

20. The method of claim 19 further comprising:
coupling one of the at least one insert to the frame by inserting the tabs of the insert into the corresponding slots in the frame.
